(19) United States
(12) Patent Application Publication
(10) Pub. No.: US 2023/0104796 A1
(43) Pub. Date: Apr. 6, 2023

(54) PLANAR TRANSFORMER AND BOBBIN ASSEMBLY APPLIED THERETO

(71) Applicant: SOLUM CO., LTD., Yongin-si (KR)

(72) Inventors: Yun Sic BANG, Uiwang-si (KR); Dong Kyun RYU, Seoul (KR); Yun Seop SHIN, Anyang-si (KR); Sang Keun JI, Yongin-si (KR)

(21) Appl. No.: 17/653,254

(22) Filed: Mar. 2, 2022

(30) Foreign Application Priority Data
Oct. 6, 2021 (KR) 10-2020-0132275

(51) Int. Cl. H01F 27/06; H01F 27/32

(52) U.S. Cl. CPC H01F 27/06; H01F 27/325; H01F 2027/065; H01F 27/24

(57) ABSTRACT

The following disclosure relates to a planar transformer and a bobbin assembly applied thereto, and more particularly, to a planar transformer in which pins may be firmly fixed through a bobbin body, a bobbin assembly may be conveniently assembled to a transformer board using snap protrusions of the bobbin body, and a total height of the planar transformer may be lowered using a flange part at the time of mounting the planar transformer, and a bobbin assembly applied thereto.

### CROSS-REFERENCE TO RELATED APPLICATION

The present application claims priority to Korean Patent Application No. 10-2021-0132275, filed on Oct. 6, 2021. The entire contents of the above-listed application are hereby incorporated by reference for all purposes.

### TECHNICAL FIELD

The following disclosure relates to a planar transformer and a bobbin assembly applied thereto, and more particularly, to a planar transformer in which pins may be firmly fixed through a bobbin body, a bobbin assembly may be conveniently assembled to a transformer board using snap protrusions of the bobbin body, and a total height of the planar transformer may be lowered using a flange part at the time of mounting the planar transformer, and a bobbin assembly applied thereto.

### BACKGROUND

A transformer is a device changing alternating current (AC) voltage and current values using electromagnetic induction, and is one of necessary parts for electronic products. The transformer is manufactured by winding coils around a large magnetic core. A primary coil of the coils is connected to an input circuit in which a voltage is to be changed, and a secondary coil of the coils is connected to an output circuit in which the changed voltage is used.

Recently, in a flat panel display (FPD) market such as a liquid crystal display (LCD), a plasma display panel (PDP), and an organic light emitting diode (OLED), a demand for research into a technology for slimming a total size of a product appearance has increased.

FIG. 1 is a view illustrating a planar transformer according to the related art. In general, the planar transformer 3 has a structure in which a core part 4 around which a coil is wound is disposed on a transformer board 5. FIG. 2 is a view illustrating that the planar transformer according to the related art is mounted on a main printed circuit board (PCB) 9, and may have a structure in which the planar transformer 3 is seated on the main PCB 9 and linear pins 6 penetrates through the transformer board 5 and the main PCB 9 to connect the transformer board 5 and the main PCB 9 to each other.

Meanwhile, when such a planar transformer is installed at a normal position on the main PCB as described above, a height of an upper surface of the main PCB to the uppermost portion of the planar transformer becomes a height of the planar transformer. In such a type of planar transformer, there is a problem that it is difficult to further lower the height of the planar transformer and a flat panel display may no longer be configured to be slim.

### RELATED ART DOCUMENT

### Patent Document

Korean Patent No. 2063754 (2017 Aug. 9)

### SUMMARY

An embodiment of the present disclosure is directed to providing a planar transformer in which pins may be firmly fixed through a bobbin body, a bobbin assembly may be conveniently assembled to a transformer board using snap protrusions of the bobbin body, and a total height of the planar transformer may be lowered using a flange part at the time of mounting the planar transformer, and a bobbin assembly applied thereto.

In one general aspect, a bobbin assembly provided on a transformer board of a planar transformer mounted on a main printed circuit board (PCB) includes: a bobbin body; and a flange part protruding from the bobbin body and having a lower surface mounted on an upper surface of the main PCB.

The lower surface of the flange part may be positioned at a higher position than a lower surface of the transformer board.

The bobbin body may be coupled to the transformer board.

The flange part may extend from a side surface of the bobbin body and protrude from the side surface of the bobbin body by a predetermined length.

The flange part may extend from a front surface of the bobbin body and protrude from the front surface of the bobbin body by a predetermined length.

The bobbin assembly may further include one or more pins connecting the transformer board and the main PCB to each other, wherein each of the one or more pins is fixed by the bobbin body.

Each of the pins may have a shape in which it is bent at least twice.

Each of the pins may have a inverted U-shape.

A through hole through which each of the pins penetrates may be formed in the bobbin body.

A step part formed by forming a predetermined region including a portion in which the through hole is formed so as to be lower than the other region to form a step with the other region may be formed in a lower portion of the bobbin body.

A guide groove in which at least a portion of a central portion of each of the pins is accommodated may be formed in the bobbin body.

A width of the guide groove may be substantially the same as a width of each of the pins, such that each of the pins is press-fitted into the guide groove.

The bobbin body may be provided with one or more snap protrusions, such that the bobbin body is coupled to the transformer board in a snap-fit manner.

The bobbin body may be formed in a ring shape and be fitted into the transformer board.

In another general aspect, a planar transformer mounted on a main PCB includes: a transformer board; a core part positioned at a central portion of the transformer board; the bobbin assembly as described above provided on the transformer boar; and one or more pins connecting the transformer board and the main PCB to each other.

A through hole through which each of the one or more pins penetrates may be formed in the transformer board, and an end of each of the pins penetrating through the transformer board may be welded, such that each of the pins is welded and coupled to the transformer board.

Each of the pins may have a shape in which it is bent at least twice, and have one side coupled to the transformer board and the other side to the main PCB.

Each of the pins may have a inverted U-shape.

### BRIEF DESCRIPTION OF THE FIGURES

FIG. 1 is a view illustrating a planar transformer according to the related art.

FIG. 2 is a view illustrating that the planar transformer according to the related art is mounted on a main printed circuit board (PCB).

FIG. 3 is a view illustrating a planar transformer according to an embodiment of the present disclosure.

FIG. 4 is an exploded perspective view of FIG. 3.

FIG. 5 is a view illustrating a coupling structure of a transformer board and a bobbin assembly.

FIG. 6 is an enlarged view of FIG. 5 when viewed from the front.

FIG. 7 is an enlarged view of FIG. 5 when viewed from the bottom.

FIG. 8 is a perspective view of the bobbin assembly when viewed from above.

FIG. 9 is an exploded perspective view of FIG. 8.

FIG. 10 is a perspective view of the bobbin assembly when viewed from the bottom.

FIG. 11 is an exploded perspective view of FIG. 10.

FIG. 12 is a side cross-sectional view of the bobbin assembly.

FIG. 13 is a side view illustrating that the planar transformer is mounted on a main PCB.

FIG. 14 is a view illustrating a planar transformer according to another embodiment of the present disclosure.

FIG. 15 is an exploded perspective view of FIG. 14.

FIG. 16 is a side view illustrating that the planar transformer is mounted on a main PCB.

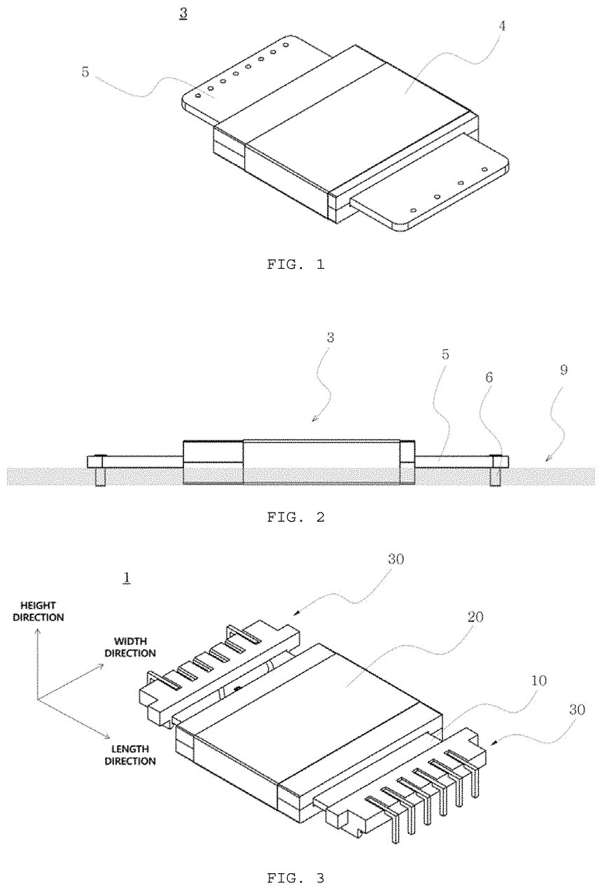

### DETAILED DESCRIPTION

Hereinafter, the present disclosure will be described in detail with reference to the accompanying drawings.

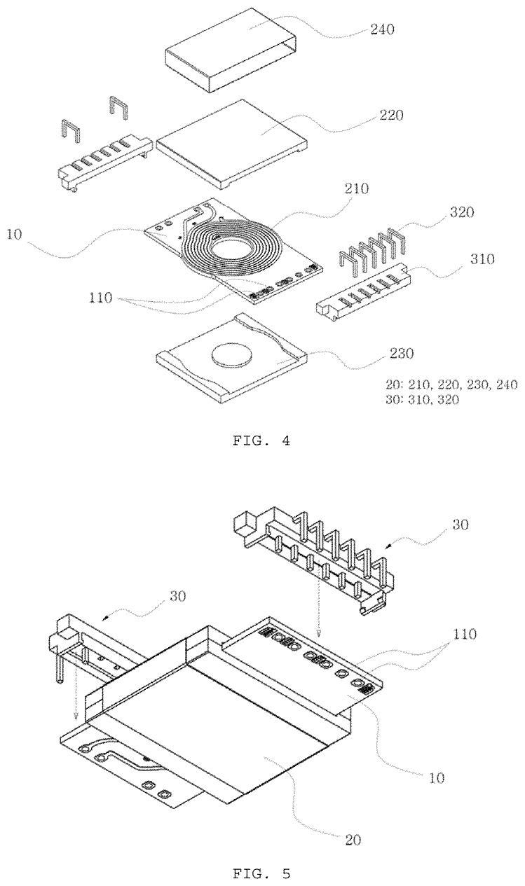

FIG. 3 is a view illustrating a planar transformer according to an embodiment of the present disclosure, and FIG. 4 is an exploded perspective view of FIG. 3. The planar transformer 1 according to the present disclosure is a planar transformer mounted on a main printed circuit board (PCB) 20, may mainly include a transformer board 10 and a core part 20 positioned at a central portion of the transformer board, and may further include bobbin assemblies 30 provided on the transformer board.

The transformer board 10 may be a single-layer PCB or a multilayer PCB including at least two or more layers, may be formed in a plate shape of which a length direction is wider than a width direction as illustrated in FIG. 3, and may be made of an insulator material such as epoxy.

The core part 20 is positioned at the central portion of the transformer board, and as illustrated in FIG. 3, the core part 20 may include a coil 210 formed at the central portion of the transformer board 10 and having a spiral shape and an upper core 220 and a lower core 230 covering the coil 210 above and below the coil 210, respectively, and may optically include a fixing tape 240 for fixing the upper core 220 and the lower core 230.

The bobbin assemblies 30 are provided on the transformer board 10, and may be provided at both ends of the transformer board 10 in the length direction, respectively, as illustrated in FIG. 3. Hereinafter, the bobbin assembly 30 according to an embodiment of the present disclosure will be described in detail.

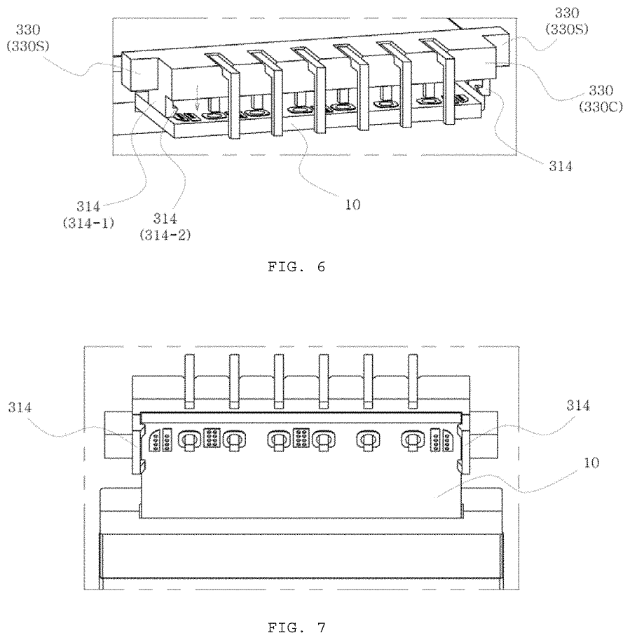

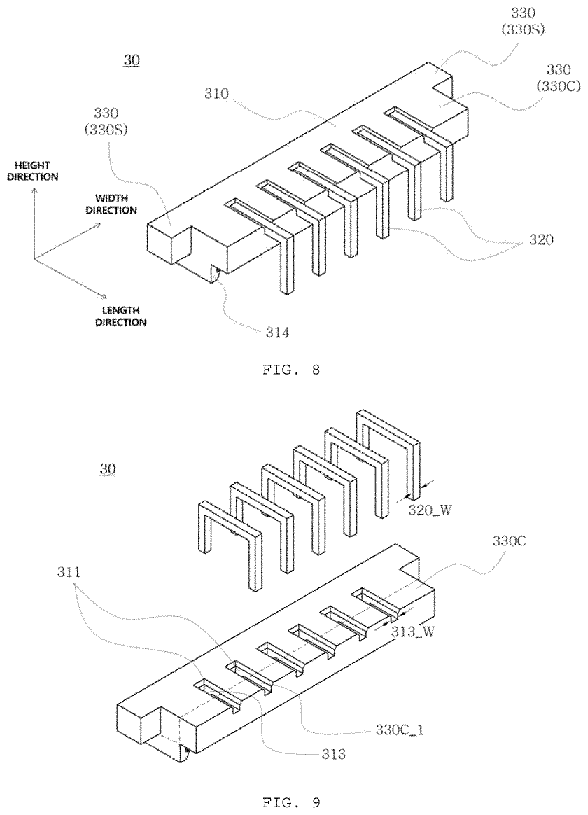

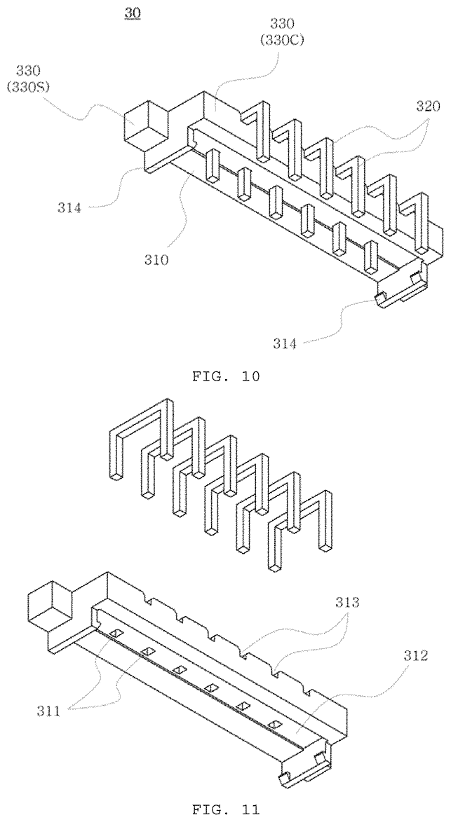

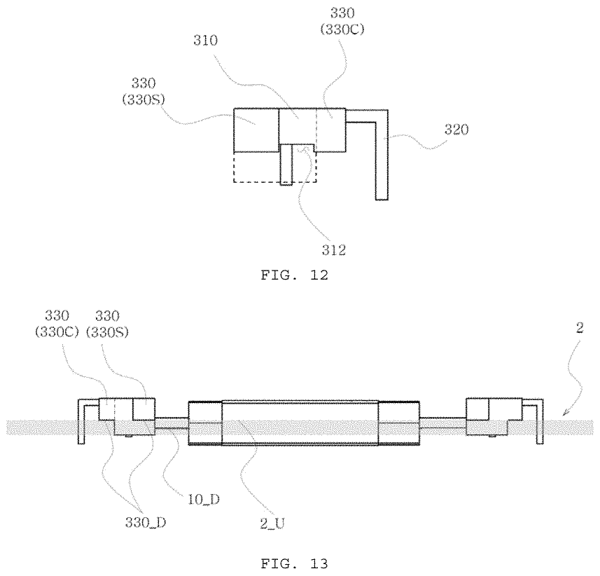

FIG. 5 is a view illustrating a coupling structure of a transformer board and a bobbin assembly, FIG. 6 is an enlarged view of FIG. 5 when viewed from the front, and FIG. 7 is an enlarged view of FIG. 5 when viewed from the bottom. In addition, FIG. 8 is a perspective view of the bobbin assembly when viewed from above, FIG. 9 is an exploded perspective view of FIG. 8, FIG. 10 is a perspective view of the bobbin assembly when viewed from the bottom, and FIG. 11 is an exploded perspective view of FIG. 10.

As illustrated in the drawings, the bobbin assembly 30 according to the present disclosure is a structure provided on the transformer board, and may mainly include a bobbin body 310 and pins 320.

The bobbin body 310 corresponds to a base structure of the bobbin assembly 30, and may perform a function such as a function of providing a place where the pins 320 are fixed as described later, providing a space in which a flange part 330 allowing the transformer board 10 to be seated at a low position on the main PCB 2 is provided, and providing a space in which snap protrusions 314 allowing the bobbin body 310 to be easily mounted on the transformer board 10 are formed.

The bobbin body 310 is not limited in its shape, but may be formed so that a length of the bobbin body 310 in the width direction is substantially the same as a length of the transformer board 10 in the width direction so that the length in the width direction so as to corresponds to the length of the transformer board 10 in the width direction, and may be disposed adjacent to an end side of the transformer board 10 in the length direction as an example.

The pins 320 connect to the transformer board 10 and the main PCB 2 to each other, and one or pins 320 may be provided and may be each fixed by the bobbin body 310. As the respective pins are fixed by the bobbin body as described above, inconvenience caused by rotation or falling-off of the pins may be removed, and the bobbin body to which the pins are coupled and fixed may be easily mounted on the transformer board, which may help to accurately position the pins at desired positions on the main PCB when the planar transformer will be later mounted on the main PCB.

In this case, each pin 320 may have a shape in which it is bent at least twice. For example, as illustrated in the drawings, each pin 320 may have a inverted U-shape, such that one side thereof may be coupled to the bobbin body 310 and the other side thereof may be opened, the opened other side of each pin 320 may be coupled to the main PCB 2 when the planar transformer will be later mounted on the main PCB 2.

Here, in a case where the main PCB 2 is a hole type PCB in which through holes (not illustrated) are formed, the other side of each pin may penetrate through each of the through holes of the main PCB without additionally bending the pin having the inverted U-shape, and be then coupled to the main PCB by welding. Alternatively, in a case where the linear transformer is mounted on the main PCB in a surface mounted device (SMD) type, the other end of the pin may be made to horizontal to an upper surface of the main PCB by additionally bending the opened other side of the pin once or more. In addition, although not illustrated, an additional bent part having a inverted U-shape may be formed at the opened other side of the pin, and may be seated on an upper portion of the main PCB.

Since the pin is configured in the bent shape, as a specific example, the inverted U-shape, as described above, the transformer board may be disposed in parallel with the main PCB in a horizontal direction without a structural restriction according to the related art that the transformer board cannot but be disposed on the main PCB in a case where a linear pin is used, and accordingly, a height of the planar transformer may be significantly lowered.

Referring to the drawings again, through holes 311 through which the respective pins 320 penetrate may be formed in the bobbin body 310, and one sides of the pins 320 may penetrate through the corresponding through holes 311 to be coupled to the bobbin body 310. The through holes of the bobbin body 310 may have a structure in which they are positioned in parallel with and are in communication with through holes 110 of the transformer board 10 to be described later. Therefore, one side of the pin 320 may be configured to pass through both the bobbin body 310 and the transformer board 10.

Referring to FIGS. 10 and 11 again, a step part 312 formed by forming a predetermined region including a portion in which the through holes 311 are formed so as to be lower than the other region to form a step with the other region may be formed in a lower portion of the bobbin body 310. More specifically, FIG. 12 is a side cross-sectional view of the bobbin assembly 30, and as illustrated in FIG. 12, the lower portion of the bobbin body 310 may include the step part 312 formed by recessing a predetermined region on the right side of FIG. 12 by a predetermined depth inwardly as compared with a left region to form a step with the left region. The step part is formed, such that an air passage through which air may pass is secured through the step part, which helps to allow beads to be introduced into the transformer board by a flow of the air at the time of welding an end of the pin penetrating through bobbin body and the transformer board after coupling the bobbin assembly to the transformer board, resulting in good welding.

Referring to FIGS. 8 and 9 again, guide grooves 313 in which at least portions of the central portions of the respective pins 320 are accommodated may be formed in the bobbin body 310. The central portion of each pin 320 may correspond to, for example, a central portion of the pin positioned in the horizontal direction when each pin is formed in the inverted U-shape. A plurality of guide grooves 313 may be formed in a shape in which they are dug inwardly from an upper portion of the bobbin body 310 by a predetermined depth, may have a structure in which they are connected to the through holes 311 of the bobbin body 310 described above, and may be formed to be spaced apart from each other by a predetermined distance in the width direction. Meanwhile, the pins 320 may be provided in all of the plurality of guide grooves 313 or through holes 311, respectively, or may be provided in only some of the plurality of guide grooves 313 or through holes 311, which may be appropriately changed in design.

In this case, a width 313_W of the guide groove 313 is substantially the same as a width 320_W of each pin 320, such that each pin 320 may be press-fitted into the guide groove 313. That is, the width of the guide groove 313 may be the same as that of each pin 320 or the width of the guide groove 313 may be slightly smaller than that of each pin 320 to allow the pin 320 to be semi-permanently fixed at the time of fitting the pin 320 into the guide groove 313. Accordingly, the pin may be conveniently and firmly fixed to the bobbin body without an additional structure for fixing the pin.

Referring to FIGS. 5 to 7 again, the bobbin body 310 may be provided with one or more snap protrusions 314, and the bobbin body 310 may be coupled to the transformer board 10 in a snap-fit manner using the snap protrusions 314. The snap protrusion 314 may have a structure in which a support part 314-1 protrudes downwardly from the bobbin body 310 by a predetermined length and a protrusion 314-2 is formed inwardly at an end side of the support part 314-1, for example, as illustrated in FIG. 6, and a plurality of snap protrusions 314 may be provided at a lower portion of the bobbin body 310. Through such a structure, when the bobbin body 310 is pressed and coupled to the transformer board 10 in a direction from the top of the transformer board 10 toward the bottom of the transformer board 10, the bobbin body 310 may be coupled to the transformer board 10 in the snap-fit manner by the snap protrusions 314. Accordingly, it is possible to manufacture the bobbin assembly separately from the core and the transformer board, such that manufacturability may be improved. In this case, the bobbin assembly may be very conveniently coupled to the transformer board.

Furthermore, the bobbin assembly 30 according to the present disclosure may further include a flange part 330 having a lower surface mounted on an upper surface 2_U of the main PCB 2.

FIG. 13 is a side view illustrating that the planar transformer is mounted on a main PCB. As illustrated in FIG. 13, the lower surface 330_D of the flange part may be seated on the upper surface 2_U of the main PCB 2. In this case, the lower surface 330_D of the flange part may be configured to be positioned at a higher position than the lower surface 10_D of the transformer board. Accordingly, a total height of the planar transformer may be further lowered as compared with the related art in which the transformer board is seated on an upper portion of the main PCB, such that a height of the planar transformer becomes higher.

That is, in the related art, the transformer board is stacked on the main PCB, such that a total thickness of a PCB is the sum of a thickness of the main PCB and a thickness of the transformer board, while in the present disclosure, the planar transformer has a structure in which the flange part rather than the transformer board is stacked on the main PCB using the bobbin assembly including the flange part. In this case, the lower surface of the flange part is configured to be positioned higher than the lower surface of the transformer board, such that the transformer board may be disposed at a lower position by a height difference. Accordingly, a height of an entire packaging of the PCB is lowered, such that the entire packaging may be configured to be very slim.

The flange part 330 is not particularly limited in its shape, structure, position, and the like, but as illustrated in FIG. 8 by way of example, the flange part 330 may extend from a side surface of the bobbin body 310 and protrude from the side surface of the bobbin body 310 by a predetermined length (330S) or may extend from a front surface of the bobbin body and protrude from the front surface of the bobbin body by a predetermined length (330C).

In a case where the flange part 330 is formed on the side surface of the bobbin body 310, when such a flange part 330 is referred to as a side flange part 330S, the side flange part 330S may be formed on each of both side surfaces of the bobbin body 310. In addition, it has been illustrated in the drawings that the side flange part 330S is disposed to be biased toward one end of the side surface of the bobbin body 310, but the present disclosure is not limited thereto, and the side flange part 330S may also be disposed at the other end or the central portion of the side surface of the bobbin body 310, and furthermore, may also have a structure in which it lengthily extends from one end of the side surface of the bobbin body 310 to the other end the side surface of the bobbin body 310. In a case where the flange part is formed on the side surface of the bobbin body, the flange part supports the planar transformer in the width direction of the transformer board, which may be useful in preventing rotation of the planar transformer in the width direction.

In a case where the flange part 330 is formed on the front surface of the bobbin body 310, when such a front flange part 330C is referred to as a front flange part 330C, the front flange part 330C may have a structure in which it lengthily extends from one end of the front surface of the bobbin body 310 to the other end of the front surface of the bobbin body 310 as illustrated in FIG. 8, but is not limited thereto and may also be positioned only in a partial region of the front surface of the bobbin body 310. Here, referring to FIG. 9 again, guide grooves 330C_1 in which at least portions of the central portions of the pins 320 are accommodated may be formed in the front flange part 330C, and the guide grooves 330C_1 of the front flange part may have a structure in which they are connected to the guide grooves 313 formed in the bobbin body 310 described above. In a case where the flange part is formed on the front surface of the bobbin body, the flange part may support the planar transformer in the length direction of the transformer board to prevent rotation of the planar transformer in the length direction, and the guide grooves may be further formed in the flange part to more firmly fix the pins.

As described above, the bobbin assembly 30 according to the present disclosure has the above-described structural features, and thus may firmly fix the pins, may be easily coupled to the transformer board, and may lower the total height of the planar transformer.

Hereinafter, the planar transformer 1 according to an embodiment of the present disclosure will be described. In this regard, a detailed description for contents overlapping those described above will be omitted.

Referring to FIGS. 3 to 5 again, the planar transformer 1 according to the present embodiment may be configured to include the transformer board 10, the core part 20 positioned at the central portion of the transformer board, and the above-described bobbin assembly 30 provided on the transformer board.

In this case, through holes 110 through which the respective pins penetrate may be formed in the transformer board 10, and the respective pins 320 of the bobbin assembly may penetrate through the transformer board 10 through the corresponding through holes 110. Furthermore, ends of the respective pins 320 penetrating through the transformer board 10 are welded, such that the respective pins 320 may be welded and coupled to the transformer board 10.

That is, the planar transformer 1 according to the present embodiment may have a structure in which the bobbin assembly 30 is coupled or assembled to the transformer board 10, and the ends of the respective pins 320 penetrating through the transformer board 10 are soldered to a lower side of the transformer board 10, such that the bobbin assembly 30 is finally welded and coupled to the transformer board 10. Thereafter, the other ends of the respective pins 320 in the planar transformer 1 in which the bobbin assembly is welded and coupled to the transformer board 10 are connected to the main PCB 2, such that the planar transformer 1 may be mounted on the main PCB 2. In this case, as described above, the planar transformer and the main PCB may be easily coupled to each other by the bobbin assembly, the pins may be accurately positioned at desired positions on the main PCB, and the total height of the planar transformer may be lowered.

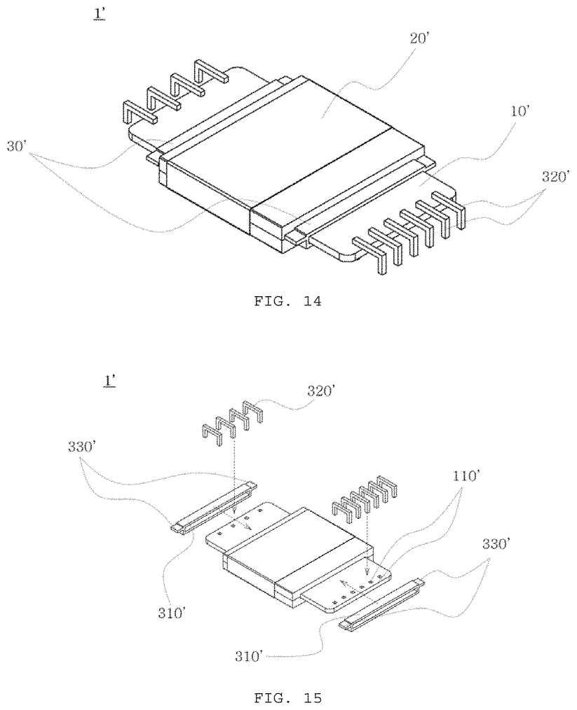

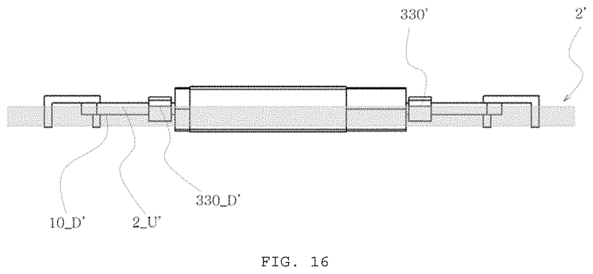

Hereinafter, a planar transformer according to another embodiment of the present disclosure will be described. FIG. 14 is a view illustrating a planar transformer according to another embodiment of the present disclosure, and FIG. 15 is an exploded perspective view of FIG. 14. As illustrated in FIGS. 14 and 15, a transformer 1′ according to the present embodiment may be configured to a transformer board 10′, a core part 20′, and one or more pins 320′.

Through holes 110′ through which one or more pins 320′ penetrate, respectively, may be formed in the transformer board 10′, and each pin 320′ may have a shape in which it is bent at least twice and may have one side coupled to the transformer board 10′ and the other side to a main PCB 2′. In this case, each pin 320′ may have a inverted U-shape.

Referring to 14 and 15, the planar transformer 10′ according to the present embodiment may further include a bobbin assembly 30′. The bobbin assembly 30′ may be configured to include a bobbin body 310′ and flange parts 330′.

More specifically, the bobbin body 310′ may be formed in a ring shape of which an inner portion is hollowed and may be configured in a form in which it surrounds an outer peripheral surface of the transformer board and is fitted onto the transformer board 10′, and the flange parts 330′ may protrude from both side surfaces of the bobbin body 310′ by a predetermined length, and may be configured so that a lower surface 330_D′ thereof is seated on an upper surface 2_U′ of the main PCB 2′. In this case, the lower surface 330_D′ of the flange part 330′ may be positioned at a higher position than a lower surface 10_D′ of the transformer board 10′.

FIG. 16 is a side view illustrating that the planar transformer is mounted on a main PCB. As illustrated in FIG. 16, the planar transformer according to the present embodiment may have a total height lowered through the flange part, and may have a structure significantly simpler than that of the planar transformer 1 according to the embodiment described above.

According to the present disclosure, the pins may be firmly fixed through the bobbin body, the bobbin assembly may be conveniently assembled to the transformer board using the snap protrusions of the bobbin body, and the total height of the planar transformer may be lowered using the flange part at the time of mounting the planar transformer.

Although embodiments of the present disclosure have been hereinabove described with reference to the accompanying drawings, those skilled in the art to which the present disclosure pertains will be able to understand that the present disclosure may be implemented in other specific forms without departing from the spirit or essential feature of the present disclosure. Therefore, it is to be understood that embodiments described hereinabove are illustrative rather than being restrictive in all aspects.

Detailed Description of Main Elements

| | |
|---|---|
| 1: planar transformer | 10: transformer board |
| 110: through hole | 20: core part |
| 210: coil | 220: upper core |
| 230: lower core | 240: fixing tape |
| 30: bobbin assembly | 310: bobbin body |
| 311: through hole | 312: step part |
| 313: guide groove | 314: snap protrusion |
| 320: pin | 330: flange part |
| 2: main PCB | |

1. A bobbin assembly provided on a transformer board of a planar transformer mounted on a main printed circuit board (PCB), comprising:
a bobbin body; and
a flange part protruding from the bobbin body and having a lower surface mounted on an upper surface of the main PCB.

2. The bobbin assembly of claim 1, wherein the lower surface of the flange part is positioned at a higher position than a lower surface of the transformer board.

3. The bobbin assembly of claim 1, wherein the bobbin body is coupled to the transformer board.

4. The bobbin assembly of claim 3, wherein the flange part extends from a side surface of the bobbin body and protrudes from the side surface of the bobbin body by a predetermined length.

5. The bobbin assembly of claim 3, wherein the flange part extends from a front surface of the bobbin body and protrudes from the front surface of the bobbin body by a predetermined length.

6. The bobbin assembly of claim 3, further comprising one or more pins connecting the transformer board and the main PCB to each other,
wherein each of the one or more pins is fixed by the bobbin body.

7. The bobbin assembly of claim 6, wherein each of the pins has a shape in which it is bent at least twice.

8. The bobbin assembly of claim 7, wherein each of the pins has a inverted U-shape.

9. The bobbin assembly of claim 6, wherein a through hole through which each of the pins penetrates is formed in the bobbin body.

10. The bobbin assembly of claim 9, wherein a step part formed by forming a predetermined region including a portion in which the through hole is formed so as to be lower than the other region to form a step with the other region is formed in a lower portion of the bobbin body.

11. The bobbin assembly of claim 6, wherein a guide groove in which at least a portion of a central portion of each of the pins is accommodated is formed in the bobbin body.

12. The bobbin assembly of claim 11, wherein a width of the guide groove is substantially the same as a width of each of the pins, such that each of the pins is press-fitted into the guide groove.

13. The bobbin assembly of claim 6, wherein the bobbin body is provided with one or more snap protrusions, such that the bobbin body is coupled to the transformer board in a snap-fit manner.

14. The bobbin assembly of claim 1, wherein the bobbin body is formed in a ring shape and is fitted into the transformer board.

15. A planar transformer mounted on a main PCB, comprising:
a transformer board;
a core part positioned at a central portion of the transformer board;
the bobbin assembly of claim 1 provided on the transformer boar; and
one or more pins connecting the transformer board and the main PCB to each other.

16. The planar transformer of claim 15, wherein a through hole through which each of the one or more pins penetrates is formed in the transformer board, and
an end of each of the pins penetrating through the transformer board is welded, such that each of the pins is welded and coupled to the transformer board.

17. The planar transformer of claim 16, wherein each of the pins has a shape in which it is bent at least twice, and has one side coupled to the transformer board and the other side to the main PCB.

18. The planar transformer of claim 17, wherein each of the pins has an inverted U-shape.
